(19) United States
(12) Patent Application Publication
(10) Pub. No.: US 2004/0133347 A1
(43) Pub. Date: Jul. 8, 2004

(54) Automated resource management system (ARMSTM)

(76) Inventor: John T. Britt, Champaign, IL (US)

Correspondence Address: HUMPHREYS ENGINEER CENTER SUPPORT ACTIVITY, ATTN: CEHEC-OC, 7701 TELEGRAPH ROAD, ALEXANDRIA, VA, 22315-3860, US

(21) Appl. No.: 10/729,269

(22) Filed: Dec. 8, 2003

(51) Int. Cl. G06F 19/00

(52) U.S. Cl. 702/1

(57) ABSTRACT

The Automated Resource Management System (ARMS™) automates collection, integration, analysis, reporting and archiving of data in a variety of applications while insuring data accuracy and reliability not attainable conventionally. Applications include: environmental, safety, security, military, educational, emergency management, land use, fish and wildlife management, construction and maintenance of highways and waterways, mining, exploration, manufacturing, recreational management, urban restoration, and archaeological preservation. ARMS™ integrates a number of portable devices, employing digital technology and specialized software in these portable devices as well as analysis devices, such as PCs and servers. ARMS™ increases efficiency and reduces cost, while accurately and timely preserving and integrating information. It is useful for both post-processing and real-time reporting, analysis, and pro-active direction of ongoing investigations.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This patent and related ones are available for licensing. Contact Bea Shahin at 217 373-7234 or Phillip Stewart at 601 634-4113.

### BACKGROUND

The United States has enacted a variety of environmental and cultural preservation laws, e.g., the National Environmental Protection Act (NEPA), the National Historic Preservation Act (NHPA), and the Clean Water Act (CWA). Further, complex investigations are mandated from this legislation, such as Environmental Site Assessments (ESA) and Environmental Impact Statements (EIS), as well as various state, local, and tribal requirements.

Compliance with these often requires one to inventory, manage, and conserve both natural and cultural resources. The competing needs of environmental sustainability and efficient land use often require implementation of complex, integrated programs to reconcile the two. Central to this issue is the need to collect, inventory, and process field data and maintain accurate and consistent records. Conventional methods for doing this are expensive and inefficient, in large part due to manual operations involved. Further, operational exigencies often lead to important information being missed or recorded improperly. Factors such as the training and experience of personnel, inconsistent data collection practices, and inherent opportunity for error in manually taking data adversely affect the quality of the final product.

Commercial off-the-shelf (COTS) tools available for environmental and cultural resources data collection are typically single-purpose units with limited, if any, ability to integrate with complementary units. With increased emphasis to implement and maintain sustainable environmental practices and protect our archaeological heritage, innovative technologies and applications are needed. A solution is provided in a capability provided by the Automated Resource Management System™ (ARMS™) of the present invention. ARMS™ automates data collection and integrates information to facilitate inventorying, analysis, reporting and archiving.

### SUMMARY

ARMS™ may be used to automate the collection, integration, analysis, reporting and archiving of data in a variety of applications while insuring data accuracy and reliability not attainable using conventional approaches. These applications include but are not limited to: environmental, safety, security, military, educational, emergency management, land use, fish and wildlife management, construction and maintenance of highways and waterways, mining, exploration, manufacturing, recreation management, urban restoration, and archaeological preservation. ARMS™ integrates a number of portable devices, employing digital technology and specialized software in these and analysis devices, such as PCs and servers that may be portable or at fixed installations. ARMS™ increases efficiency and reduces cost, while accurately and timely preserving and integrating information critical for use by decision makers.

ARMS™ applications range from simple routine measurements taken as part of an ongoing monitoring effort to complex specialized investigations of a scientific nature that may involve both natural and cultural resource investigations, e.g., inventory, evaluation, and mitigation of erosion at archaeological sites. Specific applications may include development, sustainability, and rehabilitation efforts such as those undertaken at environmental clean-up sites. ARMS™ may be used as a powerful tool to facilitate decision making for both short and long-term planning, e.g., monitoring of historic properties or assessing invasive species encroachment. ARMS™ optimizes data collection and manipulation practices and may provide an automated quality assurance function. In operation, ARMS™ may facilitate timely and objective feedback for implementing real-time methodological improvements in data collection, analysis, reporting, and archiving.

One embodiment of ARMS™ may include:

a client/server application comprising:

two or more small, ruggedized, sun shielded, portable computers for manually recording and integrating data from a variety of sources such as: Personal Digital Assistants (PDAs), communication devices, sensors, instruments, scanners, A/D converters, specialized data entry forms, aerial photography, mapping programs, timers, and cameras;

a desktop PC or a ruggedized portable PC functioning as the server to post-process data and to run other applications;

high-resolution instrumentation, preferably employing digital signal processors (DSPs), such as digital cameras with video and audio capabilities, differential global positioning systems (GPS), laser range finders, inclinometers, altimeters, thermometers, barometers, compasses, code labelers/inserters such as barcode labelers, radars, LADARs, sonar devices, spectrometers, and clocks; and

sufficient hardware interfaces to handle various types of data, store it to a common shared database and synthesize it, some of which data includes: Geographic Information System (GIS) data (compliant with Federal Geographic Data Committee (FGDC) and Spatial Data Standard for Facilities, Infrastructure, and Environment (SDSFIE) standards), GPS data, manually entered data, and data taken from associated media such as video and audio;

purpose-built data collection devices;

software to interface with and integrate commercial-off-the-shelf (COTS) and specially developed software applications;

an embedded GIS;

communications devices, including fiber optic, infrared, RF, and digital wireless devices that transmit and store data for remote uploading and downloading to the server; and

devices to print or insert coded labels, such as bar-coded labels.

The embedded GIS provides geo-spatially referenced attribute data that expedites the resolution of spatial relationships such as environmental management issues. For critical land-use decisions, real-time wireless transmission of data and images are available, enabling ARMS™ to serve a remote decision maker while the system is actually deployed in the field.

ARMS™ components may incorporate ergonomics in their design for ease of setup and use. The system is flexible in that it allows the user to select and pre-load software applications and configure hardware tailored for the specific type and level of investigation, e.g., wetlands delineation, cultural resources inventory, and habitat assessment. Project data and GIS coverages, such as survey transects and sample plot coordinates, may be pre-loaded prior to deployment. This ensures accuracy and efficiency and eliminates delays. The portable (laptop or handheld) PCs may be uploaded with interactive databases that may be populated either automatically via integrated elements or from hardware attached to expansion ports, or both. To assure compatibility, all databases may adhere to 3^{rd} normal form data structure standards.

ARMS™ achieves significantly improved data collection, data reliability and data handling while optimizing stewardship, compliance, sustainability and readiness capabilities. Because of its flexibility, ARMS™ may be applied to areas as diverse as:

Cultural Resources

Archaeological Resources Protection Act (ARPA) investigations

Accident Assessments

Traffic accidents

Insurance adjustments

Damage Assessments

Natural

Military

Terrorist, and

Criminal Investigations.

Further advantages of the present invention will be apparent from the description below with reference to the accompanying drawings, in which like numbers indicate like elements.

### BRIEF DESCRIPTION OF THE DRAWINGS

FIG. 1 depicts the general classes of devices used in implementing an embodiment of the present invention.

FIG. 2 is a block diagram of steps that may be used in processing data when implementing an embodiment of the present invention.

FIG. 3 is a block diagram of steps that may be used in processing collected samples when implementing an embodiment of the present invention.

FIG. 4 is a cartoon of the steps that may be used in employing an embodiment of the present invention.

### DETAILED DESCRIPTION

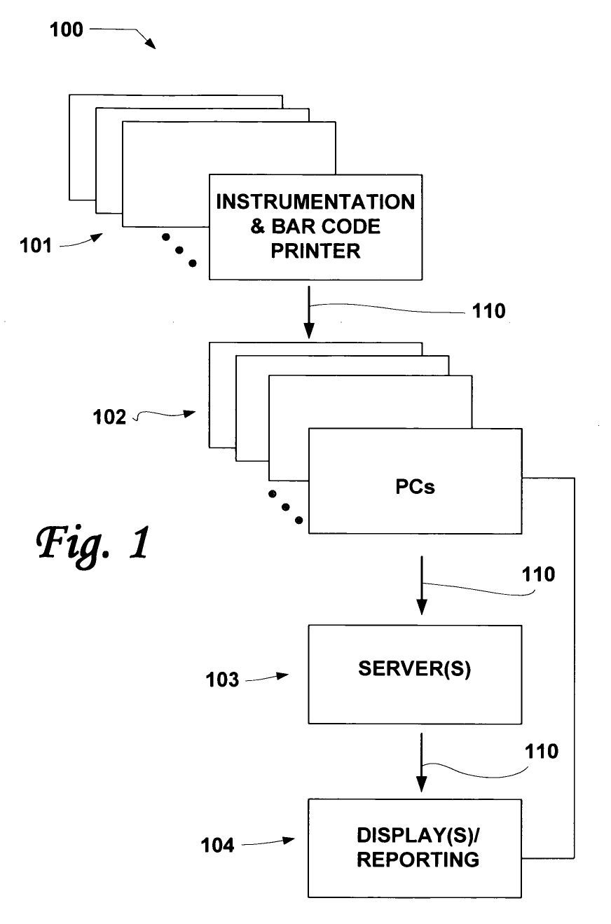

Refer to FIG. 1. A generic approach 100 using principles of an embodiment of the present invention is presented. Various pieces of instrumentation 101, to include one or more bar code readers in certain applications, are provided to the field investigator or technician. The number and types of instrumentation devices 101 are specified in accordance with a plan for assessing, remediating, investigating, processing, analyzing, evaluating, preserving, etc., that involves at least some data collection. A barcode printer provided as part of the instrumentation 101 may be a standalone device or affixed as an accessory to a device such as a personal computer (PC) 102.

The instrumentation 101 is configured to communicate 110 with one or more PCs 102, which may be hand-held, laptop, or desktop devices. Communication 110 with the PCs may be via any of a number of hard-wired devices such as a keyboard, a pointing device or mouse; any of various electrical or electro-optical cables interconnecting intermediate communications devices such as PDAs, digital cameras, microphones, and the like; and by wireless means such as are possible using infrared (IR), ultraviolet (UV), visible light, RF, acoustic or ultrasonic sources.

Data communicated 110 to each of the PCs 102 is appropriately time-stamped, if not already done by the instrumentation 101 itself, and in certain applications merged with appropriate data from other sources communicating 110 with the PCs 102 or with one or more databases that may be loaded on the PCs 102.

Data collected and processed on the PCs 102 may be further analyzed, collated, merged, stored, or otherwise processed at one or more servers 103. These servers 103 may be integral with a single one of the PCs 102 and used as a stand-alone system in the field, be one or more separate PCs 102 also deployed to the field or at a fixed location to communicate 110 with the PCs 102 use to collect data, or one or more mini-computers or a mainframe located in a mobile instrumentation van (not shown separately) or at a fixed site, or a combination of the above.

A number of reporting vehicles and displays 104 for assisting in analyzing, processing, reporting, and distributing the results of a field collection effort may be in communication 110 with the PCs 102 and server(s) 103. For example, in stand-alone applications, the CRT of a desktop PC 102 or flat panel LCD of a laptop PC 102 may be a sufficient display device with INTERNET or other data connection (phone line, cable, wireless) for reporting or communicating. Data storage may be to any of several types of media, including remote servers, tape, hard disk or portable media such as removable hard disk, RW-CD, DVD, video tape, storage media associated with digital cameras, and floppy disk.

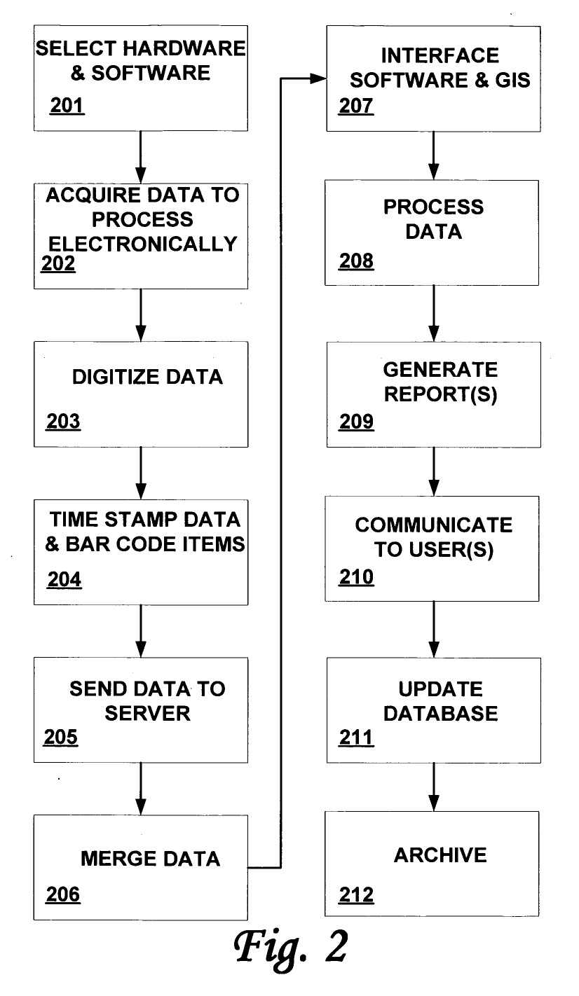

Refer to FIG. 2 in which a block diagram of the process for handling data to be collected from an assessment or investigation is described. Prior to fielding an assessment or investigation, the user requirements for performing the assessment or investigation will lead to establishing the necessary hardware and software selected 201 for the job. Data are acquired 202 by any of a number of means, including manual sampling; manually recorded observation; audio or video recording; digital photography; sensors and detectors such as RF, sonic, ultrasonic, chemical, and light (visible, UV, IR); active transmitters such as lasers, any of the various types of radars, and special purpose weather, air and water sampling instrument packages. Any of these data that are analog are then digitized 203 for further electronic processing.

Preferably data are time stamped 204, and collected samples bar coded 204, upon collection by instrumentation 101, but time stamping 204 may also be done upon data entry into any of the PCs 102 or server(s) 103. Data collected in the field may be retained in the instrumentation 101 or PCs 102 until it is sent 205 to a server 103 that may be any of the alternatives discussed above. In the server 103, data are merged 206 to meet a user's requirements, and interfaced 207 with pre-specified software and appropriate GIS software and systems. The merged data may then be processed 208 in pre-specified formats to facilitate documentation of the assessment or investigation. A variety of reports may be generated 209 to summarize results of this processing. These reports are then made available to users 210 in any of a variety of forms to include: hardcopy; electronic formats such as those available at an INTERNET site; on various media (video, audio, and text); and via live or remote transmissions, including live and recorded video and audio. The processed data and reports may be used to update 211 one or more databases and may be archived 212 for reference or further use.

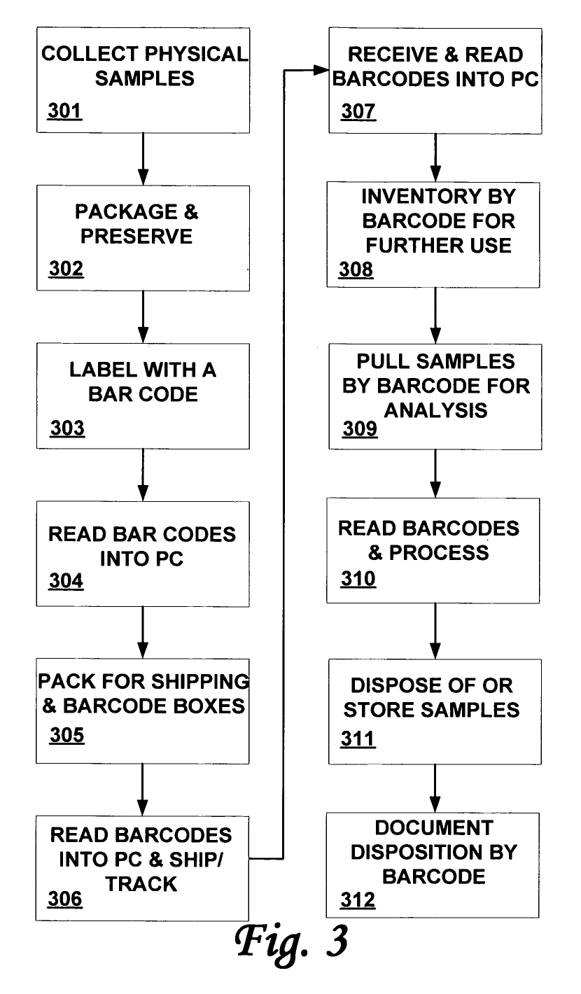

Refer to FIG. 3 in which a block diagram of an embodiment of the present invention is used to collect, identify, package, ship, and preserve physical samples. By following a pre-specified sampling plan, the number and type of required samples is collected 301. These are packaged to eliminate contamination and preserve 302 them for later investigation. To facilitate tracking and inventory, these samples are labeled 303 with a bar code and the bar codes read 304 into a PC 102 together with appropriate identification data. The samples are then packed 305 in appropriate containers for shipping, identifying the contents to an individual barcode label for the container. These barcodes are also read into a PC 102 and the container shipped and tracked 306 via the barcode. At the receiving end, the containers are received 307, status updated to an inventory location 308, and the bar codes read into PCs 102. The samples are then accessed 309 for further investigation or analysis by correlation to container and individual sample bar codes. Prior to processing the samples, the individual bar code is read 310 into a PC 102 by an investigator or technician, the sample is processed, and if not destroyed, either disposed of or retained 311 for reference, quality control, or further analysis.

For example, in each environmental application, ARMS™ contains a series of digital forms that permit a user to progress logically. The application may guide a user through various required or recommended steps, display alternative choices, or both. Menus may consist of a series of drop-down lists with options, radio buttons, or both. For each program, links may be provided for access to pre-loaded or website reference guides, e.g., soil descriptions, artifact typologies, plant references, and architectural elements. Each form may be customized for a unique application. Each form may incorporate space to manually enter data or free-form comments. To ensure accuracy and efficiency, each form in a progression of forms may be required to be filled out completely before the program advances to the next form.

A novel feature of an embodiment of ARMS™ is the incorporation of one or more features that may initiate a number of measurements simultaneously using a single input device such as a single click of a mouse or pushing a single button. In the case of taking data about an environment at a particular time, this would provide a “snapshot” that includes a time stamp simultaneously applied to an entire data set.

For example, an operator of a data collection unit of ARMS™ may aim sensors incorporated in the unit at a target and press a record button. This action may capture a digital image, measure the distance to the target, obtain GPS positioning, azimuth, inclination, elevation and other metric attributes, and store the data in a database with a time stamp and unique identifier (barcode) attached. Because the data are collected digitally it allows for immediate verification of the quality and usefulness of the data. Finally, the collected data, i.e., forms, GPS, GIS shape files, video and audio images, are downloaded from a field unit, typically a PC 102, to a base computer that may be a PC 102. This may be done in a one-step process using an infrared, wired or radio frequency (RF) connection between the client 102 and server computers. The server computer, which may have more powerful software tools, may be used for additional processing and analysis. A feature of the ARMS™ that contributes to increased efficiency is an automated, pre-programmed function on the server that is structured to generate customized reports from specific data files, such as archeological site forms, and plant or animal inventories, or both, thereby eliminating transcription errors.

In one embodiment of the present invention, field specimens such as artifacts, soils, minerals, and plants are collected, bagged and affixed with a unique bar code label in the field. The labels are printed on archival quality material and include text descriptions, e.g., project I.D and provenience. Bar coding facilitates automated inventory, tracking and retrieval of the specimen throughout the life cycle of the project, while enhancing curation and research capabilities.

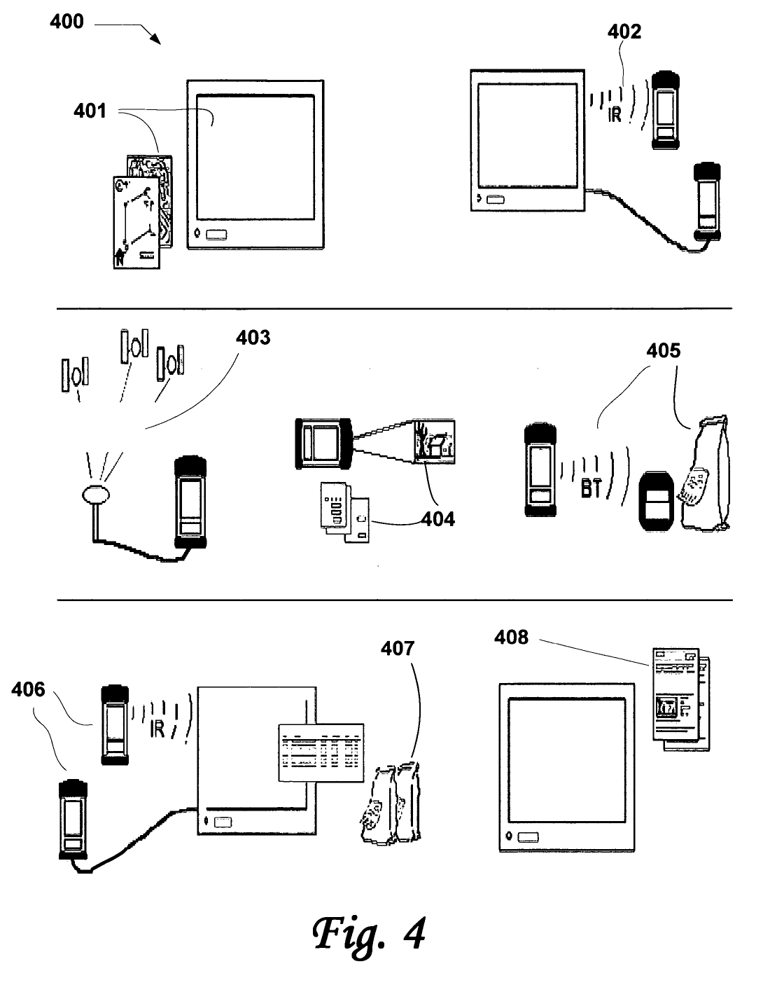

Refer to FIG. 4 representing a method 400 for employing an embodiment of the present invention by:

uploading data 401 such as maps, aerial photographs, and other geo-referenced data into a pre-specified project file using a software program such as SOLO OFFICE;

compiling information 402 such as base maps and project information and copying these over as a whole to client devices running a software program such as SOLO FIELD

logging GPS data 403 such as coordinates and elevation on client devices;

prompting field users 404 to enter data regarding the field survey that is being conducted at that station, including, for example, recording form data as well as any notations, photographs, video, or dictation;

recovering and bagging 405 material such as artifacts while documenting same, for example, by assigning a bag number with relevant station data and transmitting the number to print a label for the collection bag onsite;

uploading data 406 to a server for further processing, such as consolidation and implementation of checklists;

checking 407, such as implementing a menu of quality control or assurance procedures, to insure that all data have been properly recorded and collected material bagged and, for example, insuring that consolidated GIS data facilitates in-field spot-checking for anomalies prior to leaving the field; and,

in those cases where the server used in the field is not the final processor, uploading consolidated files 408 to either a centralized server or back-up tape or CD.

Equipment that may be employed in an embodiment of the present invention for one field client includes:

a ruggedized TDS® Recon handheld personal computer (PC) with a 400-MHz INTEL® x-scale processor, 64 MB SDRAM, 128 MB flash storage, 15-hr battery life, and weight of 490 g;

a GARMIN® N17 GPS receiver, 3-meter accuracy, serial cable, 12 v, NiMH battery with 8-hr life, and weight of 373 g;

a SOCKET BLUETOOTH® Kit, with COMPACTFLASH® card and PC card adaptor;

an IBM® 1-GB MICRODRIVE® for COMPACTFLASH®,

a SONY CYBERSHOT® DSC-FX77 digital camera, 4 MP, 320×240 V/A,

BLUETOOTH® communication, and weight of 185 g;

INTERMEC® PB20 ruggedized direct thermal portable printer, 293 dpi, 8-hr battery life, BLUETOOTH® communication, and weight of 393 g; and

SOLO OFFICE and SOLO FIELD software.

While the invention has been described in terms of some of its embodiments, those skilled in the art will recognize that the invention can be practiced with modifications within the spirit and scope of the appended claims. For example, although the system is described in specific examples for recording results of archaeological investigations, it will operate in any number of applications including military, industrial, commercial, recreation, mining, geophysical exploration, and agriculture. Thus, it is intended that all matter contained in the foregoing description or shown in the accompanying drawings shall be interpreted as illustrative rather than limiting, and the invention should be defined only in accordance with the following claims and their equivalents.

I claim:

1. A configuration for managing collection of samples and collecting, preserving, integrating, processing and communication of information at locations that may be remote from a fixed power source, comprising:
a client-server system comprising:
at least one portable device having at least some of the capabilities of a personal computer;
wherein said portable device may be used for said collecting, preserving, integrating, processing and communication of at least some of said information; and
at least one computer;
wherein said computer is available to communicate with said portable device, and
wherein said computer may function as said server to post-process data and to run pre-specified software applications;
at least one instrumentation device,
wherein said instrumentation device may communicate directly with said portable device, said computer or another said instrumentation device;
at least one hardware interface,
wherein said hardware interface may be employed between said instrumentation device and said portable device, between said instrumentation device and said computer, between said portable device and said computer, and between two or more items of said instrumentation, of said portable device, and of said computer;
at least one software interface,
wherein said software interface may be employed between said instrumentation device and said portable device, between said instrumentation device and said computer, between two or more items of said instrumentation, between said portable device and said computer, and within said portable device, within said computer and within said instrumentation device;
at least one software program for running a Geographic Information System (GIS), said program accessible to at least one of said portable device, said computer and said instrumentation,
wherein said GIS provides geo-spatially referenced attribute data that expedites the resolution of spatial relationships;
at least one communications device,
wherein said communications device facilitates communication among at least said portable device, said computer and said instrumentation device; and
at least one device to provide coded labels,
wherein said device to provide coded labels facilitates inventorying and tracking of any of said samples that are physical samples.

2. The configuration of claim 1 in which said communications devices are selected from the group consisting essentially of: laptop computers, cellular telephones, satellite telephones, two-way radios, Personal Digital Assistants (PDAs), cameras, wireless communication devices, land lines, encryption devices, fiber optic wireless devices, infrared wireless devices, RF wireless devices, and combinations thereof.

3. The configuration of claim 1 in which said instrumentation device is selected from the group consisting essentially of: cameras, digital cameras with video and audio capabilities, sensors, instruments, optical scanners, analog-to-digital (A/D) converters, timers, clocks, inclinometers, altimeters, thermometers, barometers, compasses, differential global positioning systems (GPS), laser range finders, radars, LADARs, sonar devices, spectrometers, digital signal processors (DSPs) and combinations thereof.

4. The configuration of claim 1 in which said variety of sources is selected from the group consisting essentially of: specialized data entry forms, aerial photographs, mapping programs, Geographic Information System (GIS) data, GIS data compliant with Federal Geographic Data Committee (FGDC) and Spatial Data Standard for Facilities, Infrastructure, and Environment (SDSFIE) standards, GPS data, manually entered data, video data, audio data, analog data, digital data, and combinations thereof.

5. The configuration of claim 1 in which said portable device is selected from the group consisting essentially of: laptop computers, personal computers, PDAs, purpose-built data collection devices, and combinations thereof.

6. The configuration of claim 1 in which said computer is selected from the group consisting essentially of: personal computers, laptop computers, desktop computers, mini-computers, mainframe computers, and combinations thereof.

7. The configuration of claim 1 in which said device to provide coded labels provides at least one bar code.

8. A method for managing the collecting, preserving, integrating, processing and communication of information at locations remote from a fixed power source, comprising:
establishing requirements for said managing;
selecting a mix of hardware and software to meet said requirements;
procuring said hardware and software; and
integrating said hardware and software,
wherein said integrating facilitates said collecting, preserving, integrating, processing and communicating of said information.

9. The method of claim 8 further managing collection of samples by identifying said samples by a code, a date/time stamp associated with said code, and by a collection location associated with said code.

10. The method of claim 8 further comprising time tagging said information.

11. The method of claim 8 further comprising merging location data with said information.

12. The method of claim 11 in which said location data is provided at least in part from GPS data provided by least one GPS receiver incorporated as part of said hardware.

13. The method of claim 8 in which said integrating is performed at least in part using commercial-off-the-shelf (COTS) software.

14. The method of claim 8 in which said integrating further comprises using interactive databases as part of said software uploaded on at least one computer incorporated as part of said hardware.

15. The method of claim 8 in which said software facilitates access to at least one Geographic Information System (GIS).

16. The method of claim 8 in which said integrating is of at least two discrete pieces of said information, said integrating accomplished via the execution of a single step.

17. The method of claim 16 in which said single step is selected from the group consisting essentially of: clicking a mouse, pushing a button, activating a switch, entering a command into a computer, touching a video screen, a voice command, activating a tone, employing a source of electromagnetic energy, and combinations of the above.

18. The method of claim 16 in which said discrete pieces of information include at least data on location of collection of said information and time of collection of said information.
